(19) United States
(12) Patent Application Publication
(10) Pub. No.: US 2012/0050638 A1
(43) Pub. Date: Mar. 1, 2012

(54) FLAT SCREEN AND HOUSEHOLD APPLIANCE EQUIPPED THEREWITH

(75) Inventors: Hans Klaus Nussbächer, Munchen (DE); Eberhard Weidner, Nürnberg (DE)

(73) Assignee: BSH BOSCH UND SIEMENS HAUSGERÄTE GMBH, Munich (DE)

(21) Appl. No.: 13/266,463

(22) PCT Filed: Apr. 26, 2010
(86) PCT No.: PCT/EP2010/055520

§ 371 Date: Oct. 27, 2011

(30) Foreign Application Priority Data
May 14, 2009 (DE) 10 2009 003 127.8

(51) Int. Cl. G02F 1/1333

(52) U.S. Cl. 349/58

(57) ABSTRACT

A flat screen includes an LCD matrix display element having a liquid crystal layer that is enclosed between a front pane on an observer side and a rear pane and surrounded on its narrow sides by a metallic enclosure. Disposed in front of the LCD matrix display element is a cover pane which supports an electrically conductive layer. The conductive layer is in conducting contact with the enclosure, with the enclosure extending forwards beyond the conductive layer.

The present invention relates to a flat screen, which can be used in particular but not only in a household appliance. Such a screen can be used to display operating information relating to the household appliance for the user but can also display images that are not or at least not necessarily related to the operation of the household appliance, for example television programs or internet pages.

Many embodiments of flat screens with an LCD matrix display element are known. Conventionally they comprise an image field with two transparent panes, between which a liquid crystal layer is enclosed. Polarizing and in some instances color-filtering layers are configured on the panes. One of the panes also has a matrix of transparent electrodes to which a voltage can be applied individually, opposite which there is a similarly transparent ground coating on the other pane. The panes are enclosed at their edges by a generally metallic frame, which holds the panes together and protects their edges against damage due to impact from a lateral direction.

As light passes through the liquid crystal layer, its polarization is rotated to an extent which is a function of an electrical potential difference along the path and therefore of the electrical potential of an electrode the light crosses on its path. To control the potentials of a plurality of electrodes, high-frequency electrical signals are required, which are propagated on long conductor tracks across the display element, emitting considerable electromagnetic radiation in the process. Many display elements available on the market emit electromagnetic radiation to a degree that no longer complies with current legal requirements. When such display elements are incorporated in a flat screen, appropriate measures have to be taken to attenuate the radiation intensity in the environment of the screen.

One known measure for emission attenuation is the use of a cover pane, which is positioned between the matrix display element and an observer and is provided with a transparent, electrically conducting coating. Because the conducting coating is “grounded” on a metallic frame of the matrix display element, radiation emission in the direction of an observer can be reduced. However this is not sufficiently possible with every model of matrix display element to comply with the legal requirements.

The object of the invention is therefore to create more effective radiation attenuation at a flat screen with less outlay.

The object is achieved in that in a flat screen with an LCD matrix element, which comprises a liquid crystal layer that is enclosed between a front pane on the observer side and a rear pane and surrounded on its narrow sides by a metallic enclosure, and a cover pane disposed in front of the LCD matrix display element and supporting an electrically conductive layer, the conductive layer is in conducting contact with the enclosure and the enclosure extends forwards beyond the conductive layer.

The frame can in particular be extended so far forwards that it covers the narrow sides of the cover pane.

Surprisingly radiation attenuation results both when the conductive layer is positioned in the conventional manner on the surface of the cover pane facing the matrix display element and the enclosure resting on the narrow sides of the cover pane thus projects out beyond the conductive layer towards the observer and when the conductive layer is present on the side of the cover pane facing the observer and is grounded by way of the narrow sides on the enclosure of the matrix display element.

To ensure reliable and extensive conductive contact between the conductive layer of the cover pane and the enclosure, a metallic contact strip is expediently positioned on a peripheral zone of the cover pane, allowing contact between the conductive layer and the enclosure.

The enclosure can consist of a number of parts, one of which can be a metallic frame known per se, which engages around the edges of the front and rear panes. The contact strip can then rest directly on the frame.

The part of the enclosure resting on the narrow sides of the cover pane can expediently be formed by a deformable metal tape, which also rests on the frame.

The same metal tape can also rest on the contact strip of the cover pane to ensure the conducting connection between the layer and the frame.

For the shielding effect it is also beneficial if the metal tape has an angled limb, which touches a main surface of the cover pane in a peripheral zone of the same in a conducting manner. Both the main surface supporting the conductive layer and the main surface of the cover pane opposite it can be involved here.

To be effective, the width of the limb should preferably be at least 2 mm, but preferably 3 mm or more.

To ensure good contact between the various components of the metallic enclosure and prevent radiation leakage, a clamp can be provided, which keeps the limb of the metal tape, the frame and the cover pane pressed together.

To achieve good mechanical protection of the matrix display element by means of a fixed cover pane with minimal flat screen depth, it is expedient if a core zone of the cover pane is thicker than a peripheral zone, which overlaps with components of the enclosure of relevance for shielding, such as the frame, contact strip or limb of the metal tape.

The subject matter of the invention is also a household appliance, in particular a refrigeration appliance, having a flat screen of the type described above. Such a flat screen can in particular be positioned in the door of the household appliance, with an outer surface of the door preferably being formed in its entirety by a glass plate, behind which the flat screen is located.

Further features and advantages of the invention will emerge from the description which follows of exemplary embodiments with reference to the accompanying figures, in which:

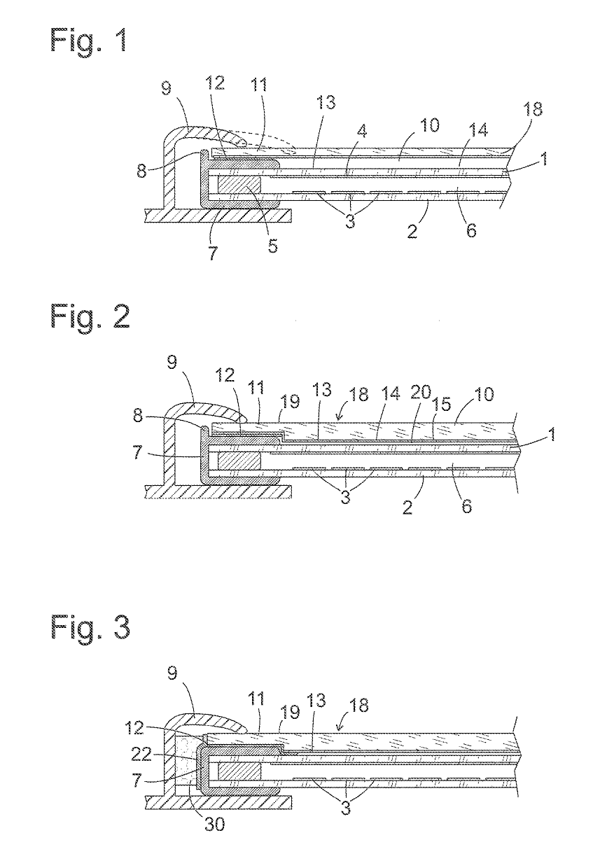

FIGS. 1 to 8 each show a partial section through a flat screen according to different embodiments of the invention; and

FIG. 9 shows a schematic perspective view of a refrigeration appliance having an incorporated flat screen.

FIG. 1 shows a cross section through the peripheral region of a flat screen according to a first embodiment of the invention. The side from which the screen can be observed is at the top in FIG. 1; a scatter surface irradiated by a light source, by which the screen is evenly illuminated from the rear and bottom, is not shown. Two panes 1, 2 made of mineral glass or a crystal-clear plastic material are provided with the standard coatings for LCD display elements, such as polarization coatings (not shown), individually activatable transparent pixel electrodes 3 and an unstructured ground electrode 4. The surface covered by the pixel electrodes 3 corresponds to the region of the screen that can be used to display images, also referred to here as the image field. In an intermediate space, which is kept free by spacers 5 and sealed at the sides, between the glass plates 1 is a liquid crystal solution 6. The rectangular glass plates 1, 2 are enclosed along their edges by a continuous frame 7, which is made up of metallic U-profiles.

A cover pane 18 made of mineral glass or a crystal-clear plastic material is held pressed against the outside of the frame 7 by a peripheral plastic enclosure 9. The cover pane 18 is provided on its side facing the display element with a transparent, electrically conductive coating of indium tin oxide, to shield electromagnetic emissions from the display element. For this shield to be effective, reliable ohmic contact is important between the coating 13 and the metallic frame 7. However tests have shown that the shielding effect is unsatisfactory if only the cover pane 18 with its conductive coating 13 is pressed against a flat front face of the frame 7. One already known measure for improving the shielding effect is to position a metallic contact strip 12 on the coating 13 in a peripheral zone 11 of the cover pane 18 that overlaps with the frame 7. Because the contact strip 12 is fixed to the coating 13, it allows closer contact with this than would be possible between surfaces of the coating 13 and of the frame 7 simply pressed directly against one another, thereby resulting in more efficient diversion of intercepted emissions into the frame 7. However with such a structure significant emissions can occur particularly at the edges of the cover pane 18. To attenuate these further, in this embodiment the frame 7 is provided with a web 8, which projects beyond its front face resting on the cover pane 18 and extends along the narrow sides of the cover pane 18. This web 8 blocks any possible egress of residual emission along the edge of the pane 18 at points where this is not sufficiently attenuated by inadequate contact between the coating 13 and the frame 7. The web 8 enhances the effect of the contact strip 12 but it would also be effective if the contact strip 12 were omitted and the frame 7 and coating 13 were in direct contact with one another.

FIG. 2 shows a second embodiment of the flat screen in a section like the one in FIG. 1. The matrix display element with the glass plates 1, 2 and the frame 7 surrounding them is identical to the one in FIG. 1 and is not described again. As in FIG. 1, a cover pane 18 has a peripheral zone 11 pressed by the enclosure 9 onto the outside of the outer frame 7 and a core zone 10 overlapping with the image field of the display element. Both have a common flat outer surface 19 but the material thickness of the core zone 10 is greater than that of the peripheral zone 11 and the inner surface 15 of the core zone 10 projects into the frame 7 towards the display element. The cover pane 18 in FIG. 2 is therefore much more rigid in its core zone 10 than the one in FIG. 1, thereby providing more effective protection against damage due to impact by an object. The wall thicknesses of the core and peripheral zones 10, 11 are tailored to the dimensions of the frame 7, to maintain an air gap 20 between the cover pane 18 and the outer glass plate 1 of typically around 100μ width. Such a distance is sufficient to prevent the occurrence of Newton's rings between the opposing surfaces of the outer pane 1 and the cover pane 18 but at the same time small enough for a reflection of the displayed image on the inner surface 15 not to be perceived by an observer with a problematic offset relative to the image displayed on the display element.

In this embodiment, as in the one in FIG. 1, the cover pane 18 is covered completely on its inner surface with a shielding conductive coating 13. In the peripheral zone 11 the coating 13 is completely covered by the metallic contact strip 12, since the three-dimensional contour of the inside of the cover pane 18 makes it difficult to restrict the contact strip 12 to part of the width of the peripheral zone 11. The contact strip 12 therefore conceals the frame 7 and, in so far as the dimensions of this core zone 10 do not correspond exactly to the exposed surface of the glass plate 1 within the frame 7, also a peripheral region of this from an observer. This is no longer problematic if the entire exposed surface of the glass plate 1 is not used to display images.

If the latter is the case, an embodiment as shown in FIG. 3 is possible, in which the conductive coating 13 is restricted to the core zone of the cover pane 18. To ground the coating 13 reliably, the contact strip 12 not only covers the entire peripheral zone 11 but also overlaps in a narrow peripheral region of the core zone 10 with the coating 13 applied thereto.

The latter embodiment has the advantage that it allows simple and economical production of the cover pane 18, in that the conductive coating 13 is first applied continuously to a large-format plate of even thickness and the plate is then broken into pieces and a peripheral zone 11 is produced on each of these pieces by pressing or by abrasive processing, said peripheral zone 11 having a smaller material thickness than the core zone 10 that remains unprocessed.

A further expedient modification of the embodiment in FIG. 3, which can be implemented independently of the above, is the replacement of the projecting web 8 with an easily deformable thin metal tape 22, which is held in close contact with the frame 7, which is C-shaped in cross section here, and the narrow sides of the cover pane 18. The metal tape 22 can be fitted at a later stage to any matrix display element enclosed in a metallic frame 7 with minimal outlay. Contact on the part of the metal tape 22 can be ensured by bonding, in the case of a frame 7 with an electrically conductive bonding agent, or by soldering or, as shown here by an elastically compressed foam body 30 clamped between the enclosure 9 and the edges of the matrix display element.

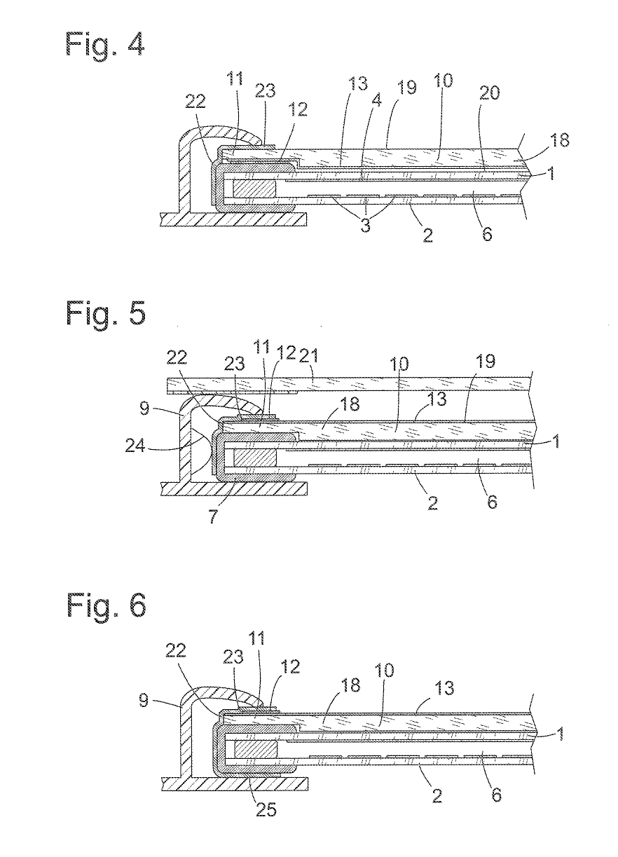

The shielding effect can be further improved with the aid of the metal tape 22 if, as shown in FIG. 4, said metal tape 22 has a limb 23 angled towards the outside of the cover pane 18. The opposing surfaces of the limb 23 and the contact strip 12 here to a certain degree form two capacitor plates, which are connected conductively along the edges of the cover pane 18, and, because they are excited to resonance over a wide band by electromagnetic emission of the display element, intercept the energy of the electromagnetic emission and prevent it from reaching the observer.

In a cover pane 18 with graduated thickness between the peripheral and core zones and a conductive coating 13 applied to the inner surface 15, as shown in FIGS. 2 to 4, it is a complex procedure just to configure the contact strip 12 on part of the width of the peripheral zone 11. However since the core zone 10 is generally somewhat smaller than the exposed surface of the glass plates 1, 2 in the interior of the frame 7, there is a risk that the contact strip 12 will restrict the visible image if the entire exposed surface of the glass plates 1, 2 is used as the image field. If the contact strip is therefore only to extend over part of the width of the peripheral zone 11, it is expedient to position the conductive coating 13 and the contact strip 12 on the flat outer surface 19 of the cover pane 18. In this instance, as shown in FIG. 5, the limb 23 of the metal tape 22 folded onto the outside of the cover pane 18 also serves to establish good contact between the contact strip 12 and the frame 7 by way of the narrow sides of the cover pane 18. The excellent shielding effect that results with the embodiment in FIG. 4 from the pairs of opposing conductive surfaces is also achieved in the instance in FIG. 5; here the conductive surfaces are formed by the contact strip 12 and the limb 23 on the outside and a limb of the frame 7 on the inside of the cover pane 18.

To protect the external coating 13 from wear, a further scratch-resistant coating, known from eye glasses for example, can be applied to said coating 13. The further coating may be omitted, if the entire flat screen, as illustrated in FIG. 4, is incorporated for its part behind a transparent pane 21 of an appliance housing. This pane 21 is expediently provided with a non-reflective coating, since otherwise, because of its distance of several mm from the matrix display element, reflections occurring at its surfaces could be perceived separately from the actual image by an observer looking at the screen from a direction away from the surface normal.

In the embodiment in FIG. 6 the metal tape 22 not only has a limb 23 pressed against the contact strip 12 on the outside of the cover pane 18 but also a limb 25 held clamped between the enclosure 9 and a rear face of the frame opposite this.

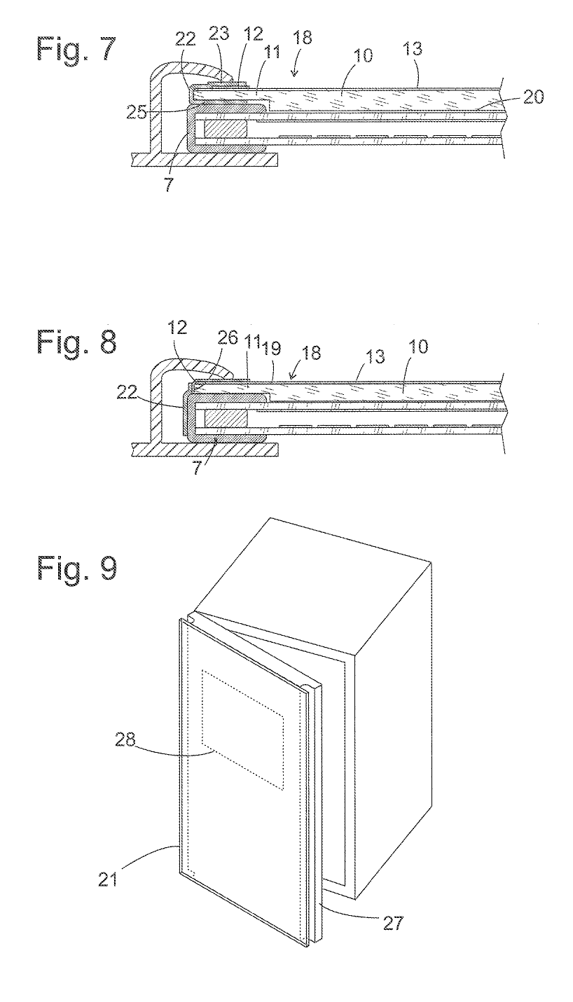

According to a modification shown in FIG. 7 a second limb 25 of the metal tape 22 can also be clamped between the peripheral zone 11 of the cover pane 18 and the front face of the frame 7. This allows the thickness of the core zone 10 to be increased by the material thickness of the metal tape 22 whilst still maintaining the width of the air gap 20, thereby making the cover pane 18 more rigid.

It is also possible to position the contact strip 12, as illustrated in FIG. 8, not only on one of the main surfaces of the cover pane 18 but also along its narrow sides 26. This allows extensive, low-resistance electrical contact to be established between the contact strip 12 and the frame 7, as in FIG. 3 by means of a metal tape 22 which does not have an angled limb but simply extends along the outside of the frame 7 and the narrow sides 26 of the cover pane 18.

FIG. 9 shows a refrigeration appliance as one example of the application of the flat screen, the flat screen being incorporated in the front face of the door 27 here. The entire front face of the door 27 is taken up by a glass plate 21, which like the pane 21 in FIG. 4 covers the entire flat screen. The glass plate 21 is printed in a non-transparent manner on its rear face, with the exception of a central blank space 28, behind which the flat screen is positioned. The edges of this blank space 28 correspond precisely to the region of the plates 1, 2 used for the image display, so that the frame 7 and the peripheral zone 11 of the cover pane 18 and together with these also the contact strip 12 and where applicable the metal tape 22 are concealed.

1-15. (canceled)

16. A flat screen, comprising:
an LCD matrix display element having a liquid crystal layer that is enclosed between a front pane on an observer side and a rear pane and surrounded on its narrow sides by a metallic enclosure; and
a cover pane disposed in front of the LCD matrix display element and supporting an electrically conductive layer, wherein the conductive layer is in conducting contact with the enclosure, with the enclosure extending forwards beyond the conductive layer.

17. The flat screen of claim 16, wherein the enclosure touches the narrow sides of the cover pane.

18. The flat screen of claim 16, wherein the enclosure comprises a metallic contact strip positioned on a peripheral zone of the cover pane and overlapping with the conductive layer.

19. The flat screen of claim 16, wherein the enclosure comprises a metallic frame, which engages around edges of the front and rear panes.

20. The flat screen of claim 18, wherein the enclosure comprises a metallic frame, said contact strip resting on the frame.

21. The flat screen of claim 20, wherein the enclosure comprises a metal tape, which rests on the narrow sides of the cover pane and on the frame.

22. The flat screen of claim 21, wherein the metal tape rests on the contact strip of the cover pane.

23. The flat screen of claim 21, wherein the metal tape comprises an angled limb, which touches a main surface of the cover pane in a peripheral zone of the cover pane in a conducting manner.

24. The flat screen of claim 23, wherein the limb has a width of at least 2 mm.

25. The flat screen of claim 21, wherein the metal tape has a limb which touches in a conducting manner a front face of the frame facing an observer.

26. The flat screen of claim 21, wherein the metal tape has a limb which touches in a conducting manner a rear face of the frame facing away from an observer.

27. The flat screen of claim 22, wherein the metal tape comprises a first limb which touches the contact strip on an outside of the cover pane, and a second limb which touches a rear face of the frame facing away from an observer.

28. The flat screen of claim 23, further comprising a clamp, which keeps the limb of the metal tape, the frame and the cover pane pressed together.

29. The flat screen of claim 25, further comprising a clamp, which keeps the limb of the metal tape, the frame and the cover pane pressed together.

30. The flat screen of claim 26, further comprising a clamp, which keeps the limb of the metal tape, the frame and the cover pane pressed together.

31. The flat screen of claim 27, further comprising a clamp, which keeps the limb of the metal tape, the frame and the cover pane pressed together.

32. The flat screen of claim 16, wherein the cover pane has a core zone of a thickness which is greater than a thickness of a peripheral zone of the cover pane.

33. A household appliance, comprising a flat screen which includes an LCD matrix display element having a liquid crystal layer that is enclosed between a front pane on an observer side and a rear pane and surrounded on its narrow sides by a metallic enclosure, and a cover pane disposed in front of the LCD matrix display element and supporting an electrically conductive layer, wherein the conductive layer is in conducting contact with the enclosure, with the enclosure extending forwards beyond the conductive layer.

34. The household appliance of claim 33, constructed in the form of a refrigeration appliance.

35. The household appliance of claim 33, further comprising a door having an outer surface formed by a glass plate, said flat screen being positioned behind the glass plate.

36. The household appliance of claim 33, wherein the enclosure touches the narrow sides of the cover pane.

37. The household appliance of claim 33, wherein the enclosure comprises a metallic contact strip positioned on a peripheral zone of the cover pane and overlapping with the conductive layer.

38. The household appliance of claim 33, wherein the enclosure comprises a metallic frame, which engages around edges of the front and rear panes.

39. The household appliance of claim 37, wherein the enclosure comprises a metallic frame, said contact strip resting on the frame.

40. The household appliance of claim 39, wherein the enclosure comprises a metal tape, which rests on the narrow sides of the cover pane and on the frame.

41. The household appliance of claim 40, wherein the metal tape rests on the contact strip of the cover pane.

42. The household appliance of claim 40, wherein the metal tape comprises an angled limb, which touches a main surface of the cover pane in a peripheral zone of the cover pane in a conducting manner.

43. The household appliance of claim 42, wherein the limb has a width of at least 2 mm.

44. The household appliance of claim 40, wherein the metal tape has a limb which touches in a conducting manner a front face of the frame facing an observer.

45. The household appliance of claim 40, wherein the metal tape has a limb which touches in a conducting manner a rear face of the frame facing away from an observer.

46. The household appliance of claim 41, wherein the metal tape comprises a first limb which touches the contact strip on an outside of the cover pane, and a second limb which touches a rear face of the frame facing away from an observer.

47. The household appliance of claim 42, further comprising a clamp, which keeps the limb of the metal tape, the frame and the cover pane pressed together.

48. The household appliance of claim 44, further comprising a clamp, which keeps the limb of the metal tape, the frame and the cover pane pressed together.

49. The household appliance of claim 45, further comprising a clamp, which keeps the limb of the metal tape, the frame and the cover pane pressed together.

50. The household appliance of claim 46, further comprising a clamp, which keeps the limb of the metal tape, the frame and the cover pane pressed together.

51. The household appliance of claim 33, wherein the cover pane has a core zone of a thickness which is greater than a thickness of a peripheral zone of the cover pane.
